(19) United States
(12) Patent Application Publication
(10) Pub. No.: US 2002/0166816 A1
(43) Pub. Date: Nov. 14, 2002

(54) Chromatography apparatus and methods

(76) Inventors: Stephen E. Allen, Milford, MA (US); Bruce M. Dawson, Wellesley, MA (US)

Correspondence Address: WILLIAM E. BOOTH, Fish & Richardson P.C., 225 Franklin Street, Boston, MA, 02110-2804, US

(21) Appl. No.: 09/855,155

(22) Filed: May 14, 2001

(51) Int. Cl. B01D 15/08

(52) U.S. Cl. 210/656; 210/198.2

(57) ABSTRACT

A disposable chromatography cartridge for separating a chemical contained in a solution, the cartridge including a vessel having an inlet and outlet and a flexible wall that is deformable by externally applied force so as to reduce a volume within said vessel, and a monolith chromatography stationary phase inside said vessel. Also disclosed are chromatography apparatus using such a cartridge, separating a chemical in a solution using such a cartridge, and a method of making such a cartridge.

### TECHNICAL FIELD

This invention relates to chromatography columns.

### BACKGROUND

Liquid chromatography is a technique for separating the individual compounds that exist in a subject sample. In employing the technique, the subject sample is carried in a liquid, called a mobile phase. The mobile phase carrying the subject sample is caused to migrate through a porous media, called a stationary phase. Different compounds will have differing rates of migration through the media, which causes the separation of the components in the subject sample. Liquid chromatography is commonly performed with reusable columns or with disposable cartridges, both of which are usually cylindrical, in which the media bed, typically resin beads, is bounded axially by porous plates, or plates containing defined flow paths, through which the mobile phase will flow into and from the media bed.

Voids in the bed of stationary phase resin beads that may have resulted during shipping and other nonuniform packing conditions can deleteriously affect the operation of chromatography column and the accuracy of results. It is known to compress flexible-walled columns (also referred to as cartridges) in order to close voids and provide uniform packing of the resin beads of the stationary phase, as described in U.S. Pat. Nos. 4,250,035 and 5,601,708, which are hereby incorporated by reference. These patents describe compressing the walls of columns by mounting the flexible-walled cartridge within a pressurizable containment structure assembly or by deflection of the walls by a mechanical member. In a chromatography system available from Dyax Corporation under the Bioflash trade designation, flexible-walled columns are subject to compression by clamping, by fluid held between the column and a containment vessel, or by a bladder that compresses the column when the bladder is expanded.

More recently, a different type of stationary phase, called a “monolith,” has been introduced. In this type of stationary phase, the polymer separation media is provided as a porous unitary structure, which can be formed inside a column by polymerizing the material inside a column, or can be preformed and then inserted into a column. The monolithic structures are based on a highly cross-linked porous monolithic polymer, with well-defined bimodal pore-size distribution, and provide good separation, chemical stability and low pressure drop during use. Because the stationary phase is provided as unitary structure, it will not suffer from the shifting of individual particles as can happen with the resin beads. Examples of such monolithic stationary phases and their manufacture are described in U.S. Pat. Nos. 6,066,258 and 6,156,206, which are hereby incorporated by reference. Monolith materials can be obtained from BioRad Laboratories, Inc. under the Uno trade designation or from BIA Separations, Slovenia or from Merck.

### SUMMARY

In one aspect, the invention features, in general, a disposable chromatography cartridge for separating a chemical contained in a solution. The cartridge includes a vessel having an inlet and an outlet, and a monolith chromatography stationary phase inside the vessel. The vessel also has a flexible wall that is deformable by externally applied force so as to reduce a volume within the vessel.

In another aspect, the invention features, in general, chromatography apparatus including a vessel having a flexible wall that deforms in response to externally applied pressure, a monolith chromatography stationary phase inside the vessel, and a wall deflector that deflects the flexible wall so as to reduce the volume within the vessel.

In another aspect, the invention features, in general, a method of separating a chemical contained in a solution using a vessel having a flexible wall, an inlet and an outlet, and a monolith chromatography stationary phase inside the vessel. The solution containing the chemical is supplied under pressure to the inlet; external force is applied to the flexible wall to deform the flexible wall, and separated solution is removed from the outlet.

In another aspect, the invention features, in general, a method of making a disposable chromatography cartridge. The method includes providing a vessel having an inlet and outlet and a flexible wall that is deformable by externally applied force so as to reduce a volume within the vessel, and providing a monolith chromatography stationary phase inside the vessel.

Particular embodiments of the invention may include one or more of the following features. The vessel can be tubular, in particular cylindrical. The flexible wall can be made of plastic, e.g., polyethylene. The monolith chromatography stationary phase can be formed within the vessel. Alternatively, the monolith chromatography stationary phase can be preformed and thereafter inserted into the vessel. The externally applied force used to deform the flexible wall can be applied by increased pressure in a pressurizable chamber in which the vessel is mounted. Alternatively the force can be applied by a mechanical member, e.g., a clamping structure that applies force to a tubular flexible wall at a plurality of locations around the periphery or by a bladder. The monolith chromatography stationary phase can be organic, polymeric or inorganic. Examples of the monolithic stationary phase include methacrylates, agrarose based materials, cellulose, acrylamides, polystyrene divinyl benzene and silica based materials.

Embodiments of the invention may include one or more of the following advantages. The application of external force and deformation of the flexible wall provides for improved separation of the chemical compound passing through the monolith chromatography stationary phase. While applicant does not wish to be bound by theory, it is believed that the external force tends to close channels that may otherwise exist between the outside of the stationary phase and the inside of the wall and which otherwise may present low pressure bypass channels. The external force may also tend to provide for more uniform flow through the stationary phase by closing voids therein. The use of flexible cartridges with monolith stationary phase has many advantages over the use of standard columns with monolith stationary phase. Because the cartridge wall is flexible, it has less expense than a standard column, which results in cost savings when the cartridges are disposed after use, as they typically are when the monolith material is formed in place. Alternatively, when the monolith is preformed, the voids that tend to result next to the chamber wall will be closed during compression, while the voids would not be closed with a standard column.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of chromatography apparatus for separating a chemical contained in a solution.

FIG. 2 is a diagrammatic, vertical sectional view of a pressure chamber and disposable cartridge of the FIG. 1 apparatus.

FIG. 3 is a diagrammatic, horizontal sectional view of a clamping structure used in place of the pressure chamber in an alternative embodiment of the FIG. 1 apparatus.

Like reference symbols in the various drawings indicate like elements.

### DETAILED DESCRIPTION

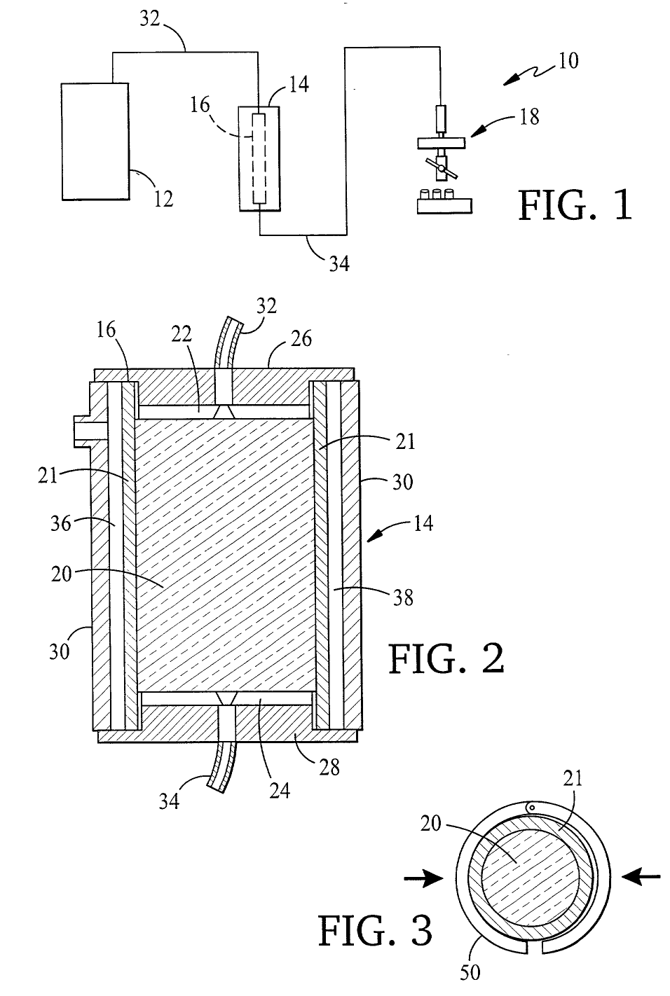

Referring to FIG. 1, there is shown chromatography apparatus 10 for separating chemicals contained in a solution. The apparatus includes source of solution 12, pressure chamber 14, disposable cartridge 16 therein, and a fraction collection device 18.

Referring to FIG. 2, it is seen that cartridge 16 includes a plug-shaped monolith chromatography stationary phase 20 in flexible-walled, cylindrical vessel 21 between inlet manifold 22 and outlet manifold 24. The monolith chromatography stationary phase can be organic, polymeric or inorganic; e.g., suitable materials include methacrylates, agrarose based materials, cellulose, acrylamides, polystyrene divinyl benzene and silica based materials. Vessel 21 is made of plastic, e.g., polyethylene and has a cylindrical shape. Chamber 14 includes top plate 26 and bottom plate 28, which are sealed to the sidewalls 30 of chamber 14. There also is a liquid tight seal between the inflow line 32 in the inlet manifold 22 and another liquid tight seal between outlet line 34 and outlet manifold 24. A source of pressurized fluid (liquid or gas) is connected to the region 36 between the flexible wall of vessel 21 and wall 30 of the pressure chamber. The pressurized liquid provides radial compression to flexible wall as described in U.S. Pat. Nos. 4,250,035 and 5,601,708 and PCT Published Applications Nos. WO97/43024 and WO99/25451, which are hereby incorporated by reference.

Stationary phase 20 can be formed in place in flexible vessel 21 or can be preformed and inserted into vessel 21. When formed in place, the stationary phase will expand, causing vessel 21 to bow out prior to the application of force, e.g., by the pressure chamber.

In operation, the chemical to be separated is contained in a solution that is fed from reservoir 12 and supplied through cartridge 16. The pressure in region 36 deforms flexible wall 21 so as to reduce the volume in the cartridge and transmit pressure through the flexible wall of vessel 21 to the monolith chromatography stationary phase 20 therein. This tends to close any gaps that might exist between the outside of the stationary phase and the inside surface of the flexible wall of vessel 21 and also tends to close voids that may exist within the phase. The effluent passes through line 34 to fraction collector 18 (FIG. 1) where separated fractions are collected. The application of external force to the flexible wall provides for improved separation of chemicals.

The embodiment of FIG. 3 differs from that of FIG. 2 in that clamping structure 50 is used to apply force to the outside of the flexible wall of vessel 21 instead of pressure chamber 14.

Because cartridges 16 are disposable, used cartridges can be removed and safely disposed of as a unit. The use of disposable cartridges reduces operator exposure to solvents, contaminants, and active ingredients. The system does not require extensive process time or post-batch cleaning.

A number of embodiments of the invention have been described. Nevertheless, it will be understood that various modifications may be made without departing from the spirit and scope of the invention. Accordingly, other embodiments are within the scope of the following claims.

What is claimed is:

1. A disposable chromatography cartridge for separating a chemical contained in a solution comprising
a vessel having an inlet and outlet, and
a monolith chromatography stationary phase inside said vessel,
said vessel having a flexible wall that is deformable by externally applied force so as to reduce a volume within said vessel.

2. The cartridge of claim 1 wherein said vessel is tubular.

3. The cartridge of claim 2 wherein said vessel is cylindrical.

4. The cartridge of claim 1 wherein said flexible wall is made of plastic.

5. The cartridge of claim 1 wherein said monolith chromatography stationary phase is formed within said vessel.

6. The cartridge of claim 1 wherein said monolith chromatography stationary phase is preformed and thereafter inserted into said vessel.

7. The cartridge of claim 1 wherein said monolith chromatography stationary phase is a material selected from the group consisting of methacrylates, agrarose based materials, cellulose, acrylamides, polystyrene divinyl benzene and silica based materials.

8. Chromatography apparatus for separating a chemical contained in a solution comprising
a vessel having a flexible wall that deforms in response to externally applied pressure so as to reduce a volume within said vessel,
a monolith chromatography stationary phase inside said vessel, and
a wall deflector that deflects said flexible wall so as to reduce the volume within said vessel.

9. The apparatus of claim 8 wherein said wall deflector includes an outer pressurizable chamber, and said vessel is mounted within said chamber such that said flexible wall is exposed to increased fluid pressure within said chamber.

10. The apparatus of claim 8 wherein said wall deflector includes a mechanical member that applies force to said flexible wall to deform said flexible wall.

11. The apparatus of claim 8 wherein said vessel is tubular, said flexible wall extends around a periphery of said vessel.

12. The apparatus of claim 8 wherein said wall deflector includes a clamping structure that applies force to said wall at a plurality of locations around said periphery.

13. The apparatus of claim 8 wherein said monolith chromatography stationary phase is a material selected from the group consisting of methacrylates, agrarose based materials, cellulose, acrylamides, polystyrene divinyl benzene and silica based materials.

14. A method of separating a chemical contained in a solution comprising
providing a vessel having a flexible wall, and inlet and outlet, and a monolith chromatography stationary phase inside said vessel,
supplying said solution under pressure to said inlet,
applying external force to said flexible wall to deform said flexible wall, and
removing separated solution from said outlet.

15. The method of claim 14 wherein said applying external force includes exposing said flexible wall to increased fluid pressure within a pressurizable chamber.

16. The method of claim 14 wherein said applying external force includes applying force via a mechanical member.

17. The method of claim 16 wherein said vessel is tubular, said flexible wall extends around a periphery of said vessel, and said mechanical member includes a clamping structure that applies force to said wall at a plurality of locations around said periphery.

18. The method of claim 14 wherein said monolith chromatography stationary phase is a material selected from the group consisting of methacrylates, agrarose based materials, cellulose, acrylamides, polystyrene divinyl benzene and silica based materials.

19. A method of making a disposable chromatography cartridge for separating a chemical contained in a solution comprising
providing a vessel having an inlet and outlet and a flexible wall that is deformable by externally applied force so as to reduce a volume within said vessel, and
providing a monolith chromatography stationary phase inside said vessel.

20. The method of claim 19 wherein said providing a monolith chromatography stationary phase includes forming said monolith chromatography stationary phase within said vessel.

21. The method of claim 19 wherein said providing a monolith chromatography stationary phase includes preforming said monolith chromatography stationary phase outside of said vessel and thereafter inserting said monolith chromatography stationary phase into said vessel.

22. The method of claim 14 wherein said monolith chromatography stationary phase is a material selected from the group consisting of methacrylates, agrarose based materials, cellulose, acrylamides, polystyrene divinyl benzene and silica based materials.
